(19) United States
(12) Patent Application Publication
(10) Pub. No.: US 2010/0101522 A1
(43) Pub. Date: Apr. 29, 2010

(54) METHOD FOR POSITIONING A CRANKSHAFT OF A SHUT-DOWN INTERNAL COMBUSTION ENGINE OF A MOTOR VEHICLE

(76) Inventors: Jie Ge, Stuttgart-Hausen (DE); Jan Lichtermann, Oberriexingen (DE)

Correspondence Address: KENYON & KENYON LLP, ONE BROADWAY, NEW YORK, NY, 10004, US

(21) Appl. No.: 12/450,709

(22) PCT Filed: Feb. 29, 2008
(86) PCT No.: PCT/EP2008/052469

§ 371 Date: Jan. 12, 2010

(30) Foreign Application Priority Data
Apr. 27, 2007 (DE) 10 2007 019 941.6

(51) Int. Cl. F02N 99/00

(52) U.S. Cl. 123/179.3

(57) ABSTRACT

The invention relates to a method for positioning a crankshaft of a turned-off internal combustion engine of a motor vehicle, wherein the crankshaft is rotated into a desired target position for the subsequent start of the internal combustion engine by means of an electric starter motor having a free wheel. The invention provides that at least one characteristic curve and/or characteristic value of a correlation between a covered rotational distance of the crankshaft and a position of the angle of rotation is determined at a standardized pulsed current duration of the starter motor for a defined operating case, that the current position of the angle of rotation of the crankshaft is determined, and that at least one estimated pulsed current duration is applied to the electric starter motor as a function of the determined position of the angle of rotation of the crankshaft and the target position and the characteristic curve/characteristic values. The invention further relates to a device for carrying out the method according to one or more of the preceding claims, comprising at least one electric starter motor having a free wheel, and a controller actuating the starter motor, and a sensor for detecting the current position of the angle of rotation of a crankshaft of an internal combustion engine.

### BACKGROUND OF THE INVENTION

1. Field of the Invention

The present invention relates to a method for positioning a crankshaft of a shut-down internal combustion engine of a motor vehicle, the crankshaft being rotated into a desired target position for the subsequent start of the internal combustion engine, using an electric starter motor having an overrunning clutch.

2. Description of Related Art

In order to start an internal combustion engine, starter motors are generally used which, in a stationary engine, engage a so-called starter pinion to mesh with a toothed wheel of the crankshaft and which turn the crankshaft via the pinion-toothed wheel meshing thus established. The crankshaft is thereby set into a rotational motion before a first ignition takes place. After the internal combustion engine is shut down, the crankshaft becomes stationary at a stable angle of rotation. This angle of rotation position is not advantageous, however, under certain circumstances, for the following start of the internal combustion engine if, for instance, none of the pistons supported in the cylinders of the internal combustion engine is at a position that is suitable for ignition.

A method of the type named at the outset is known from published German patent document DE 10 2005 004 326, in which, at standstill of the internal combustion engine, the crankshaft is brought to a target position that is optimal for starting the internal combustion engine. For this purpose, the starter motor is operated until the crankshaft has reached the desired position. Based on the overrunning clutch of the starter motor, the rotational motion of the crankshaft is able to be influenced by the starter motor in only one rotational direction. That is, the starter motor is not able to brake the rotational motion of the crankshaft. Depending on its angle of rotation position, the crankshaft has a different rotational behavior with regard to its torque. Depending on the angle of rotation position, the crankshaft may have applied to it a positive or a negative torque. The negative torque, in this context, may have the result that the crankshaft outruns the starter motor. This, in turn, may lead to overshooting the target position.

### SUMMARY OF THE INVENTION

The present invention provides that at least one characteristics curve and/or characteristic values of a relationship between a rotational path covered by the crankshaft and an angle of rotation position at a normalized pulse current duration of the starter motor is ascertained for a defined operating case, that the current angle of rotation position of the crankshaft is ascertained and that the electric starter motor has applied to it at least one estimated pulse current duration, as a function of the ascertained angle of rotation position as well as of the target position of the crankshaft and the characteristics curve/characteristic values. In the method according to the present invention, first of all, at least one characteristics curve and/or characteristic values are ascertained, which ascertains the relationship between the rotational path of the crankshaft covered and an angle of rotation position starting from which the rotational path of the crankshaft is covered, in a normalized pulse current duration applied to the starter motor, for a specified operating case. Expressed more simply, one would say that for a specified case it is ascertained how far the crankshaft moves, or rather rotates, from a certain angle of rotation position at a normalized pulse current duration. The relationships described are advantageously ascertained for a plurality of angle of rotation positions of the crankshaft, in particular, angle of rotation positions being taken into account within the range of stable positions of the crankshaft. The larger the number of observed angle of rotation positions selected, the more precisely the crankshaft is able to be positioned. The ascertaining of the characteristics curve and/or characteristic values preferably takes place ahead of time, the characteristics curve and/or the characteristic values being stored in a nonvolatile memory of a control device controlling the starter motor, so that they may be called up at any time. In order to rotate the crankshaft to the desired target position, the current angle of rotation position of the crankshaft is first ascertained when the internal combustion engine is shut down or is at a standstill. This may be done by simply using a common sensor. Of course, one may also use the signal of an appropriate sensor of the internal combustion engine that is already present. The rotational path required for reaching the target position, especially the next target position, is determined as a function of the angle of rotation position of the crankshaft. Finally, the electric starter motor has applied to it at least one estimated pulse current duration for reaching the target position, as a function of the ascertained values. That is, the starter motor has applied to it a pulse current duration which is a function of the ascertained current angle of rotation position as well as of the (next) target position, and of the “known”, previously ascertained response (characteristics curve/characteristic values) of the crankshaft, the pulse current duration being able to be estimated particularly by using the characteristics curve/characteristic values. The estimation advantageously takes place, in this instance, as a function of at least one further parameter. Because of the previously ascertained characteristics curve (and/or the characteristic values), the torques of the crankshaft that are a function of the angle of rotation position are also taken into account. Because of that, one is able to estimate in a simple manner the pulse current duration required for the starter motor, and move the crankshaft into the desired target position. The desired target position is expediently located in a stable range of the crankshaft.

According to one refinement of the present invention, the pulse current duration is estimated so that the electric starter motor has to have applied to it at least one additional pulse current duration for reaching the target position. In order not to overshoot the desired target position, the pulse current duration is thus estimated “conservatively”. This means that the pulse current duration is distributed to the extent that the desired target position is reached only after the second current pulse, as a rule. This enables one rapidly to set the desired target position in a simple manner.

After applying the (first) pulse current duration to the electric starter motor, one may advantageously ascertain an additional angle of rotation position of the crankshaft that has come to a standstill again. That is, after the starter motor has had the (first) pulse current duration applied to it, the angle of rotation position of the crankshaft is ascertained anew, as soon as the crankshaft has come to a standstill in a stable position.

It is also provided that the additional (second) pulse current duration be estimated as a function of the additionally ascertained angle of rotation position of the crankshaft and the previously ascertained characteristics curve/characteristic values. In other words, in case the crankshaft is not yet located in the target position after it has applied to it the (first) estimated pulse current duration, the abovementioned method is repeated, the new angle of rotation position being taken into account in the estimation of the further (second) pulse current duration.

In one advantageous specific embodiment of the present invention, the electric starter motor has applied to it at most three current pulse durations or three current pulses for reaching the target position. Thus, maneuvering the crankshaft to the target position is limited to at most three steps, so that a rapid setting of the crankshaft takes place. However, because of taking into account current parameters when estimating the respective pulse current duration, the target position or the target range has mostly already been reached after the second pulse current. About the approximate target position, a tolerance range is advantageously specified, in which the crankshaft may be located for an optimal rapid start of the internal combustion engine. Putting it in a different manner, a target range is specified in which the crankshaft is to be rotated for a subsequent start of the internal combustion engine.

For the estimation of the pulse current duration, the voltage of an energy store that supplies the electric starter motor with electric energy is advantageously taken into account. In particular, the deviation of a maximally possible voltage from a normalized voltage level is taken into account, so that the pulse current duration is estimated to be correspondingly shorter or longer. In addition, by taking into account the operating state of the energy store, one is also able to prevent a voltage drop in the vehicle electrical system of the motor vehicle.

According to one refinement of the present invention, the current temperature of the internal combustion engine is taken into account for estimating the pulse current duration. The temperature of the internal combustion engine in particular has effects on the coefficients of friction of the internal combustion engine. These, in turn, have a direct effect on the motion and the torque of the crankshaft. Especially when it comes to high temperatures, when the internal combustion engine has run hot, the torque of the crankshaft turns out to be lower than at low temperatures. Alternatively or in addition, the operating time of the internal combustion engine may also still be taken into account, which will have an effect, for instance, on the viscosity of a lubricant as well as the temperature of the internal combustion engine.

Moreover, for the purpose of estimating the pulse current duration, an estimating factor is advantageously taken into account, which is determined as a function of the difference/deviation of the current angle of rotation position of the crankshaft with respect to the target position. If there is a large deviation of the current angle of rotation position of the crankshaft from the target position, a greater estimating factor is expediently provided, that is, one that corrects the pulse current duration in an extended manner, or rather, corrects it upwards, than for a small interval. The result is that, the closer the crankshaft is to the target position, the smaller the motion, or the rotation, of the crankshaft turns out to be. The crankshaft is thereby advantageously led to the target position.

Furthermore, it is provided that the characteristics curve/characteristic values be ascertained for start-stop operation as an operating case of the internal combustion engine. In order to reduce fuel consumption of motor vehicles, what has particularly proven itself is shutting down the internal combustion engine during longer stopping times, as, for example, at traffic lights. This shutting down may be implemented both manually, by the driver, and mechanically and electronically by so-called start-stop operation. This, however, puts a heavy load on the starter motor, and in addition, the starting time during the following start of the internal combustion engine varies as a function of the angle of rotation position at which the crankshaft came to rest after the shutting down of the internal combustion engine. The fact that the characteristics curve/characteristic values are ascertained for a start-stop operation means essentially that the characteristics curve/characteristic values are ascertained for an internal combustion engine that is running hot. The characteristics curve/characteristic values are preferably experimentally ascertained and stored ahead of time.

The starter motor is advantageously pre-engaged. This means that the drive pinion of the starter motor is already in a meshing position with a toothed wheel of the crankshaft when the crankshaft comes to rest, so that the energy supplied to the starter motor is able to be converted directly to a rotational motion. Alternatively, it is of course also conceivable that the drive pinion be engaged only after the standstill of the crankshaft.

Furthermore, the present invention relates to a device for carrying out the above method, using at least one electric starter motor having an overrunning clutch and using a control device that controls the starter motor, as well as a sensor for detecting the current angle of rotation position of the crankshaft of an internal combustion engine. The control device according to the present invention has a current-limiting bypass circuit which is connected in parallel with the principal circuit. The starter motor is thereby able to have current pulses applied to it, for moving/turning the crankshaft to the desired target position, without switching in the principal circuit. This makes possible the separation of positioning the crankshaft from the actual start, or rather the crank-up process.

### BRIEF DESCRIPTION OF THE DRAWINGS

FIG. 1 shows a starter motor of an internal combustion engine in a simplified perspective representation.

FIG. 2 shows a functional block diagram of a control device for the starter motor.

FIG. 3 shows a diagram having stable angle of rotation ranges of a crankshaft of the internal combustion engine.

FIG. 4 shows a flow chart of an exemplary embodiment of a method according to the present invention.

FIG. 5 shows a first example of the application of the method.

FIG. 6 shows a second example of the application of the method.

FIG. 7 shows a third example of the application of the method.

### DETAILED DESCRIPTION OF THE INVENTION

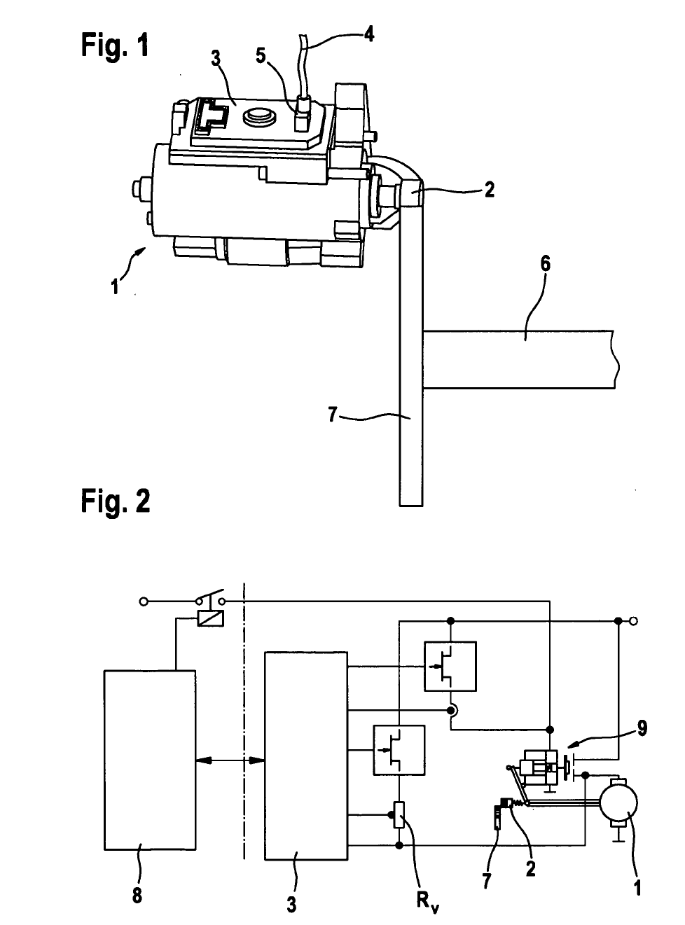

FIG. 1 shows, in exemplary fashion, a starter motor 1 of an internal combustion engine of the driving system of a motor vehicle, in a perspective representation, which has a drive pinion 2 that is able to be engaged and/or pre-engaged. A control device 3 which controls starter motor 1 is situated on starter motor 1. Control device 3 has a connecting device 4, to which a control unit (not shown here) of the drive system may be connected. Furthermore, control device 3 has a connecting device 5, to which a sensor may be connected, for detecting the angle of rotation position of a crankshaft 6, that is able to be propelled by starter motor 1. In the engaged state of drive pinion 2, shown in FIG. 1, the latter acts jointly with a toothed wheel 7 that is connected torsionally fixed to crankshaft 6, so that a rotational motion of drive pinion 2 is able to be transferred to crankshaft 6. Starter motor 1 and drive pinion 2 have an overrunning clutch, so that drive pinion 2 is able to transfer a force in only one rotational direction.

FIG. 2 shows a functional block diagram of control device 3 of starter motor 1 for a start-stop operation of the internal combustion engine. In start-stop operation, the internal combustion engine is briefly shut off or shut down, in phases during which it does not have to supply power, such as when the motor vehicle is standing in front of a red light. A control unit 8 of the drive system specifies the start-stop operation to control unit 3 of the control device. In addition, control device 3 of starter motor 1 controls an engaging device 9, which moves drive pinion 2 axially, in order to put it from the non-engaged state shown in FIG. 2 into the engaged state shown in FIG. 1. Control device 3 also has a bypass circuit connected in parallel to the principal circuit, having current limiting implemented by a series resistor R_{V}. This makes it possible to switch on normally developed starter motor 1 even in the engaged state, without closing the principal circuit.

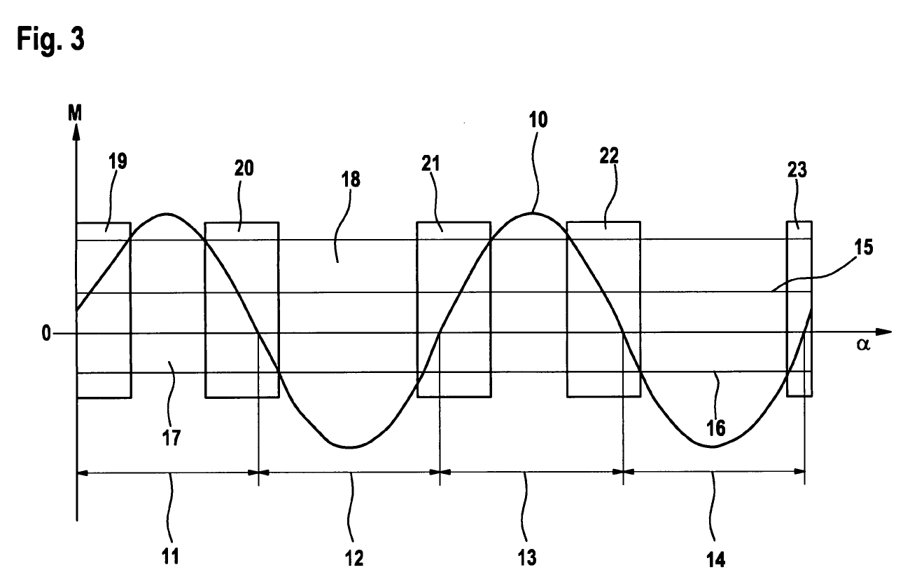

In the engaged state, starter motor 1 is able to drive crankshaft 6 of the internal combustion engine in only one direction. Depending on the angle of rotation setting of the crankshaft, a load acts on starter motor 1, in this instance. On this matter, in a diagram, FIG. 3 shows the response of the crankshaft in different angle of rotation positions. The diagram shows curve 10 of a crankshaft torque M plotted against angle of rotation position a of the crankshaft. Curve 10 has an essentially sine-shaped or cosine-shaped curve plotted against angle of rotation position a. In this context, the crankshaft runs through several pushing zones 11, 12, in which the torque is greater than zero and several pulling zones 13, 14, in which the torque is less than zero. Furthermore, in the diagram two lines 15 and 16 are drawn in which define an area 17, which reflects/represents the frictional torque of the internal combustion engine. Above line 15 another area 18 is drawn in which defines the drag torque of starter motor 1. The drag torque of starter motor 1 counteracts the back-oscillation of the crankshaft to a certain degree (circa 10 Nm). Because of the overrunning clutch, since starter motor 1 is not able to brake the crankshaft, the drag torque acts only one way in response to torques greater than zero. Curve 10 of the torque of the crankshaft has its maximum positive and negative values outside of areas 17 and 18.

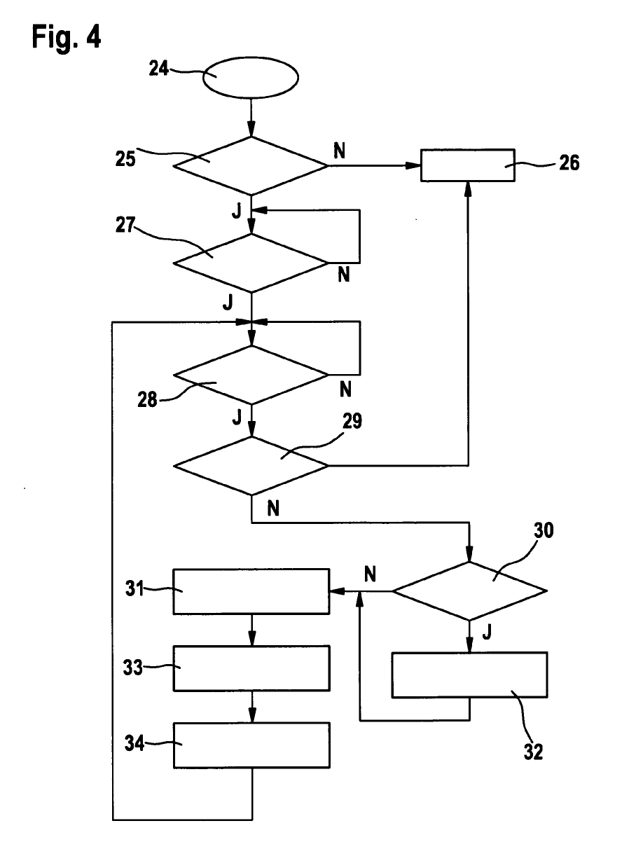

In the sections of curve 10 which lie inside areas 17 and/or 18, there are so-called stable regions 19, 20, 21, 22, 23 in which crankshaft 6 comes to a standstill after the internal combustion engine is shut down, since in these regions the friction torque of the internal combustion engine and/or the drag torque of starter motor 1 are greater than the torque of crankshaft 6. In order to ensure a rapid start of the internal combustion engine in start-stop operation, crankshaft 6 is rotated into the desired target position which lies expediently in one of stable regions 19 to 23, using the method shown in FIG. 4.

In a flow chart, FIG. 4 shows an exemplary embodiment of an advantageous method for positioning crankshaft 6 in start-stop operation when the internal combustion engine is shut down. The method is started in a first step 24. In the following query 25 it is checked whether a start-stop operation of the drive system or the internal combustion engine is present. If this is the case, for instance, if the internal combustion engine is shut down by turning the ignition key, the method is ended in a next step 26. If, on the other hand, a start-stop operation is taking place, a further query 27 is made in which it is checked whether drive pinion 2 of starter motor 1 is engaged. As soon as this, the engaging, has taken place, there follows an additional query 28, in which the operating state of the internal combustion engine is ascertained. Only when the internal combustion engine is at a standstill does a further query 29 take place. In this case, the angle of rotation position of crankshaft 6 of the internal combustion engine is checked and compared to a target position or a target range. If crankshaft 6 is located in an angle of rotation position that corresponds to a target range or a target position, this leads to breaking off the method in step 26.

If, however, using the abovementioned sensor for detecting the angle of rotation position of crankshaft 6, it is ascertained that the crankshaft is located in an angle of rotation position outside the target range or in a target position, another query 30 is made in which the magnitude of the deviation of the angle of rotation position from the target position, or rather from the target range, is determined. If the deviation is only slight, then in a further step 31 there follows a calculation of the distance of the angle of rotation setting of crankshaft 6 from the next/nearest target position or from the next/nearest target range. In doing this, an estimating factor is taken into account which is determined as a function of the distance of the current angle of rotation position of crankshaft 6 from the target position/target range. If it is ascertained in query 30 that the deviation from the target position is large, the estimating factor is corrected upwards in a step 32 following query 30.

After step 31, there follows in step 33 the determination of a pulse current duration that is applied to starter motor 1 in following step 34, in order to move crankshaft 6 into its target position or target range. The estimating factor that has been corrected upwards has the effect, in this instance, of a comparatively longer pulse current duration. As soon as crankshaft 6 of the internal combustion engine comes to a standstill again, which is ascertained by query 28, it is checked again whether the current angle of rotation position corresponds to the desired target position/target range (query 29). If this is the case, the method is ended at step 27.

However, if the crankshaft is still not in the target range or in its desired target position, the deviation from the target position is ascertained anew in query 30, an appropriate estimating factor is specified and a certain pulse current duration is applied to starter motor 1. In the calculation of the pulse current duration in step 33, at least one characteristics curve and/or the characteristic values ascertained beforehand are drawn upon, which show a relationship between a rotational path covered by crankshaft 6 and an angle of rotation position at a normalized pulse current duration of starter motor 1 for a start-stop operation. The characteristics curve or characteristic values thus reflect how far crankshaft 6 has moved out of a certain angle of rotation position because of the application of a normalized pulse current duration to starter motor 1. As was mentioned above, using these values, one is able to estimate the pulse current duration required for reaching the target position. In order to move crankshaft 6 into its target position in as few steps as possible (maximum of three), the estimating factor is specified as a function of the abovementioned parameters, such as the angle of rotation position of the crankshaft, the operating temperature of the internal combustion engine and/or the number of pulse currents. The estimating factor is advantageously specified so that, in the case of a plurality of pulse currents, or rather in the case of a plurality of adjusting motions of starter motor 1 for reaching a target position, the pulse current duration is shortened each time.

In a method step not shown in FIG. 4, the method may be broadened by taking into account additional parameters in the determination of the pulse current duration in step 33, such as the operating temperature and/or the operating time of the internal combustion engine, as well as the currently present voltage level of the energy store supplying starter motor 1 with energy.

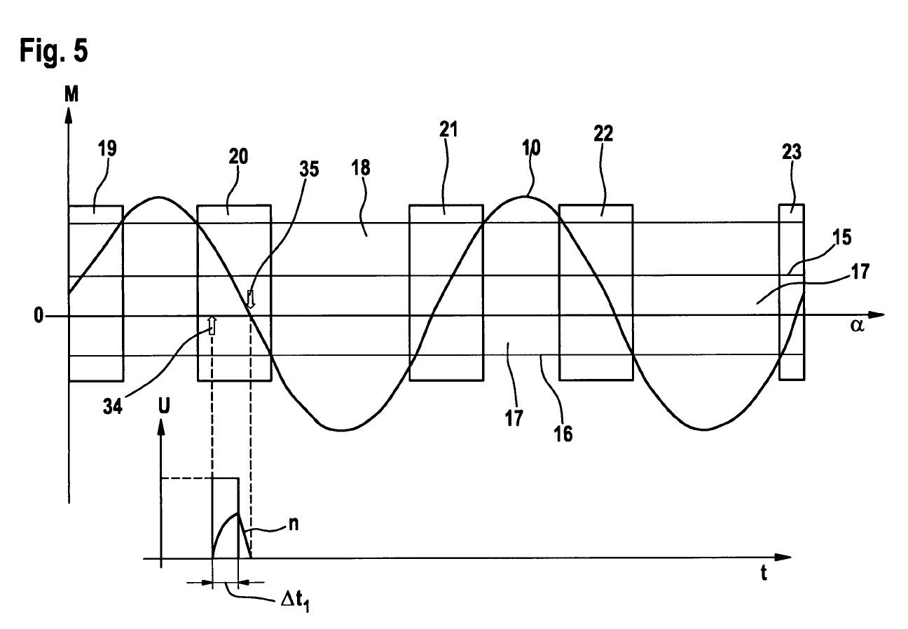

In the following FIGS. 5, 6 and 7, the advantageous method will be explained in greater detail, with the aid of a few practical examples. FIGS. 5, 6 and 7 show the diagram from FIG. 3, among other things, so that we refer to the description going with FIG. 3 for this diagram.

In the first example shown in FIG. 5, in step 29 of the method of FIG. 4 it is ascertained that crankshaft 6 is located in an angle of rotation setting 34 (marked by arrow 34). Logically speaking, angle of rotation setting 34 is located in a stable range 20. A next or next nearest target position 35 is located in the same stable range 20. As a result, it is ascertained in query 30 that the deviation from target position 35 is low, and the estimating factor that is normally specified to be small does not have to be corrected.

In the lower area of FIG. 5, a second integrated diagram is shown, which shows the voltage U applied to starter motor 1 plotted against a time t. Based on the small deviation from target position 35 ascertained in step 30, a small pulse current duration Δt₁ is determined/calculated, as a function of the “known” behavior of the crankshaft, or the characteristics curve/characteristic values, in which starter motor 1 has the voltage U applied to it. Since crankshaft 6 is located in stable range 20, its rotational speed n becomes rapidly less after the voltage application to the starter motor 1 has taken place over time Δt₁, based on the frictional forces of the internal combustion engine, until the crankshaft comes to a standstill in the target position. Thus, in the present case, a one-time application of a pulse current width Δt₁ to starter motor 1 is sufficient for moving the crankshaft into its target position 35.

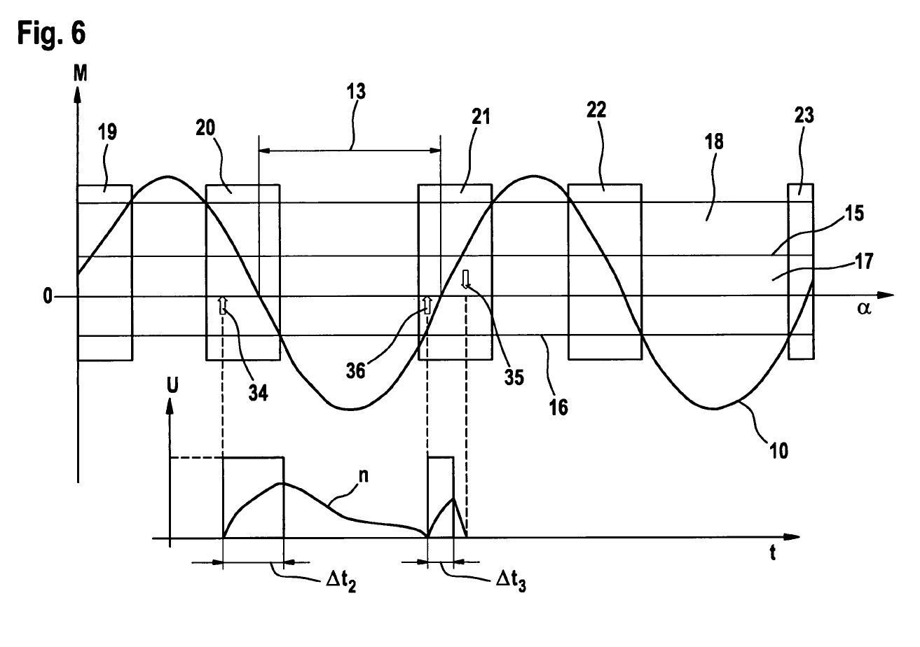

FIG. 6 shows a second example, which differs from the preceding example in that target position 35 is located after a pulling zone 13. The ascertained current angle of rotation setting of crankshaft 6 corresponds to the ascertained angle of rotation setting 34 from FIG. 5. That is, it is in stable range 20. However, the next nearest target position 35 is located in stable range 21, which follows pulling zone 13. By contrast to the previous example, in this case, in the method according to FIG. 4, the estimating factor in step 32 is corrected upwards, since the deviation of the ascertained angle of rotation setting 34 from target position 35 is large. With the aid of the ascertained characteristics curve/characteristic values, a first pulse current duration Δt₂ is first specified “conservatively”, that is applied to starter motor 1. By doing this, crankshaft 6 is moved/rotated out of stable range 20. Pulse current duration Δt₂ is selected/estimated in such a way that starter motor 1 is shut down only after the exit from stable range 20. Because of the overrunning clutch, crankshaft 6 is able to continue rotating in pulling zone 13, until it comes to a standstill in the following stable range 21. This is shown, for example, using rotational speed n in the integrated diagram in the lower area of FIG. 6. As soon as the crankshaft is located at a standstill, which is checked by query 28, its current angle of rotation setting 36 is ascertained and compared to target position 35, as was described above. Since the deviation from target position 35 now turns out to be low, a small pulse current width Δt₃ is calculated, with the aid of the characteristics curve/characteristic values, ascertained ahead of time, and the appropriately selected/determined estimating factor. Starter motor 1, which has current applied to it over estimated pulse current duration Δt₃, is speeded up so that the rotational speed n of crankshaft 6 is subsequently rapidly slowed down based on frictional forces of the internal combustion engine, until crankshaft 6 comes to a standstill in target position 35. Alternatively to a specified target position (35), a target range may naturally also be specified in which crankshaft 6 is supposed to be located.

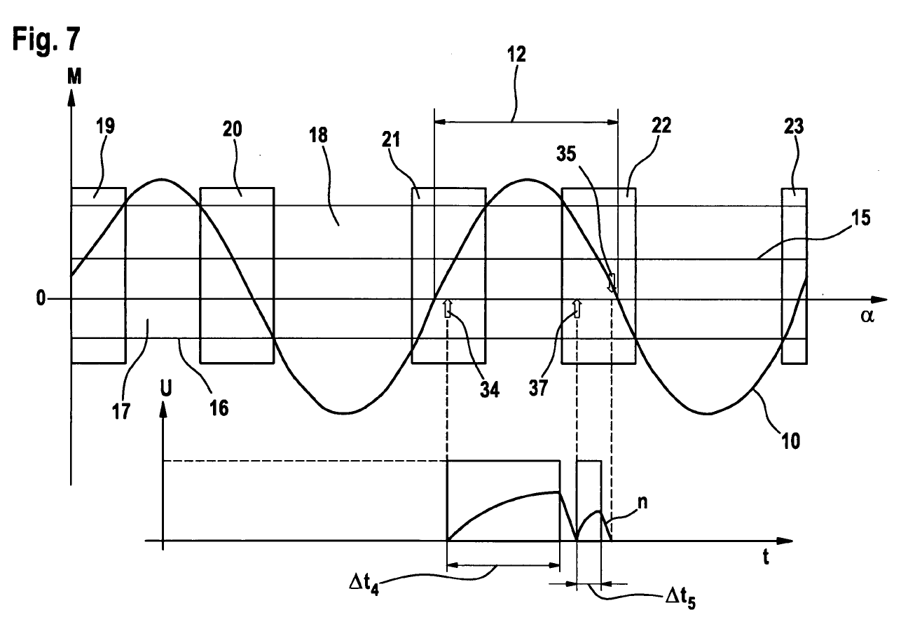

FIG. 7 shows an example for the case where target position 35 is located behind a pressing zone 14. In the example of FIG. 7, it is ascertained in the start-stop operation, using the method of FIG. 4, that the current angle of rotation setting 34 of crankshaft 6 lies in stable range 21. In this connection, based on the advantageous method, starter motor 1 has applied to it a pulse current duration Δt₄ in such a way that crankshaft 6 is driven until it reaches the following stable range 22. This is necessary since pressing zone 12 has to be bridged. Otherwise it might happen that crankshaft 6 oscillates back into stable range 21. The pulse current duration is estimated particularly correspondingly based on the known/ascertained torque response. As soon as crankshaft 6 has come to a standstill in stable range 22, a current angle of rotation position 37 is detected anew, as described above, and is compared to target position 35. In the present example, because of the advantageous method, starter motor 1 has applied to it a pulse current duration Δt₅, whereby crankshaft 6 is first speeded up. According to the advantageous method, pulse current duration Δt₅ is estimated in such a way that the rotational speed subsequently becomes reduced so that crankshaft 6 comes to a standstill in target position 35.

Because of the abovementioned predictive method, in which the characteristic values/characteristics curve(s), ascertained ahead of time, for determining in each case a pulse current duration as a function of the current angle of rotation position of crankshaft 6, it is possible in a simple manner to move crankshaft 6 into a position that is advantageous for the start of the internal combustion engine. The advantageous method gives one the possibility of positioning crankshaft 6 using a usual starter motor 1. The method may be integrated in a simple and cost-effective manner into control device 3 of starter motor 1, or alternatively, into a control device 8 (not shown here) of the drive system.

1-11. (canceled)

12. A method for positioning a crankshaft of a shut-down internal combustion engine of a motor vehicle comprising:
rotating the crankshaft into a desired target position for a subsequent start of the internal combustion engine, using an electric starter motor having an overrunning clutch;
ascertaining at least one characteristics curve or characteristic value of a relationship between a rotational path covered by the crankshaft and an angle of rotation position at a normalized pulse current duration of the starter motor for a defined operating case;
ascertaining the current angle of rotation position of the crankshaft; and
applying to the electric starter motor at least one estimated pulse current duration, as a function of the ascertained angle of rotation position of the crankshaft as well as of the target position and the characteristics curve or characteristic value.

13. The method as recited in claim 12, wherein a first pulse current duration is estimated so that the electric starter motor has to have applied to it at least one additional pulse current duration for reaching the target position.

14. The method as recited in claim 12, wherein, after the application of a pulse current duration to the electric starter motor, an additional angle of rotation position is ascertained of the crankshaft that has come to a standstill.

15. The method as recited in claim 13, wherein, after the application of a pulse current duration to the electric starter motor, an additional angle of rotation position is ascertained of the crankshaft that has come to a standstill.

16. The method as recited in claim 15, wherein the additional pulse current duration is estimated as a function of the additional angle of rotation position and the characteristics curve or characteristic value.

17. The method as recited in claim 12, wherein the electric starter motor has applied to it at most three current pulse durations for the purpose of reaching the target position.

18. The method as recited in claim 12, wherein voltage of an energy store, that supplies the electric starter motor with electric energy, is taken into account for estimating the pulse current duration.

19. The method as recited in claim 12, wherein the current temperature of the internal combustion engine is taken into account for estimating the pulse current duration.

20. The method as recited in claim 12, wherein for the purpose of estimating the pulse current duration, an estimating factor is taken into account, which is determined as a function of the distance of the current angle of rotation position of the crankshaft from the target position.

21. The method as recited in claim 12, wherein the characteristics curve or characteristic values are ascertained for a start-stop operation as an operating case of the internal combustion engine.

22. The method as recited in claim 12, wherein a drive pinion of the starter motor is pre-engaged.

23. An apparatus for carrying out the method of claim 12, comprising: at least one electric starter motor that has an overrunning clutch; a control device controlling the starter motor; and a sensor for detecting the current angle of rotation position of a crankshaft of the internal combustion engine, wherein the control device has a bypass circuit, having current limiting, that is connected in parallel to a principal circuit.
